(19) United States
(12) Patent Application Publication
(10) Pub. No.: US 2026/0099276 A1
(43) Pub. Date: Apr. 9, 2026

(54) REGISTER GROUPING AND VIRTUAL REGISTER

(71) Applicant: Microsoft Technology Licensing, LLC, Redmond, WA (US)

(72) Inventors: Samuel Chelsae KNIGHT, Portland, OR (US); Dibyendu DEY, Portland, OR (US); Dong Hyun BAIK, Portland, OR (US); Charles Parker WOOD, Portland, OR (US)

(21) Appl. No.: 18/911,113

(22) Filed: Oct. 9, 2024

(51) Int. Cl. G06F 3/06

(52) U.S. Cl. CPC G06F 3/0667; G06F 3/0604; G06F 3/0673

(57) ABSTRACT

The described technology provides a method including determining a plurality of blocks configured on a system on chip (SoC), generating a register database, wherein the register database is configured to store one or more parameters of a plurality of registers, the plurality of registers representing the registers for a plurality of blocks the SoC, determining one or more pattern strings, wherein each of the strings identify a common functionality among a plurality of registers, performing a search on a register database for identifying a group of registers from the plurality of registers, wherein names of each of the group of registers include the pattern string, and generating a virtual register that relates to the group of registers.

### BACKGROUND

Computing systems may be implemented on system on chips (SoCs) which are a type of integrated circuit (IC) design that combines many or all high-level functional elements of an electronic device onto a single chip instead of using separate components mounted to a motherboard, as is done in traditional electronics design. Typical SoCs may include a number of functional blocks, such as processors, memory units, I/O units, communication units, etc., each having a number of registers having a number of fields. Registers constitute a significant percentage of today's complex SoC designs and make up a significant portion of today's complex SoC designs. For example, in modern SoCs, the number of registers can range into the millions or sometimes into tens of millions. Specifically, on-chip registers define interface to the hardware elements on the SoCs and usually represent a large portion of the device specification and programmer's guide.

### SUMMARY

The described technology provides a method including determining a plurality of blocks configured on a system on chip (SoC), generating a register database, wherein the register database is configured to store one or more parameters of a plurality of registers, the plurality of registers representing the registers for a plurality of blocks in the SoC, determining one or more pattern strings, wherein each of the strings identify a common functionality among a plurality of registers, performing a search on a register database for identifying a group of registers from the plurality of registers, wherein names of each of the group of registers include the pattern string, and generating a virtual register that relates to the group of registers.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example implementation of a system for providing register grouping and virtual register.

FIG. 2 illustrates an alternative example implementation of a system for providing register grouping and virtual register.

FIG. 3 illustrates an example register function that may be implemented using the register grouping and virtual register disclosed herein.

FIG. 4 illustrates an alternative example register function that may be implemented using the register grouping and virtual register disclosed herein.

FIG. 5 illustrates an alternative example register function that may be implemented using the register grouping and virtual register disclosed herein.

FIG. 6 illustrates an alternative example register function that may be implemented using the register grouping and virtual register disclosed herein.

FIG. 7 illustrates an example implementation of using the virtual register to add new properties thereto.

FIG. 8 illustrates an example flowchart of providing register grouping and virtual register disclosed herein.

FIG. 9 illustrates example operations for dynamically updating the register database.

FIG. 10 illustrates an example system that may be useful in implementing the collaboration network mining technology disclosed herein.

### DETAILED DESCRIPTIONS

Modern system on chips (SoCs) are very complex, but where functional unit blocks are reused across the SoC, similar registers exist in multiple places. Writing scripts to interact with these disperse registers and fields can be quite cumbersome. For example, debugging an SoC involves a series of transactions such as read, write, core halt etc. These sequences of events form a script written in any software language. However, scripting can become cumbersome due to the vast and dispersed availability of registers and endpoints on typical SoCs.

The implementations of the system for providing register grouping as disclosed herein provides register grouping as a collection of hardware registers and by their common functionality and purpose. Here the fields are bits within a register that define specific hardware functionality. Such register grouping allows to organize similar registers and provide an application programming interface (API) for interacting with the hardware using the abstract concept of the register's purpose instead of the register's address directly. In one implementation, the collection is defined by user defined configuration files. Subsequently, a register group object is formed. Once register group object is formed, user can avail many useful functionalities for register group, doing bulk read, write, display, overwrite default LSB, MSB, and other functions.

### Technical Advantage

Providing register group objects provides a number of technical advantages including reducing lines of code that are required to manage the registers and the fields, improves organization and readability in user scripts. Additionally, the definition of the register group is based on a pattern that dynamically queries the register database to generate specific user scripts, thereby eliminating the need for continuous maintenance as the register database updates. Furthermore, the disclosed technology also adds portability to the management of registers on an SoC by making the code transferrable across different SoCs and products.

In SoCs, functional unit blocks may be replicated to build larger blocks. These functional unit blocks have similar registers with addresses relative to their joint test action group (JTAG) endpoint. Register group definitions may include a pattern of the register name and discover similar registers so that they can be programmed as a group instead of individually.

An implementation disclosed herein provides a method including determining a plurality of blocks configured on a system on chip (SoC), generating a register database, wherein the register database is configured to include one or more parameters of a plurality of registers, the plurality of registers representing the registers for a plurality of blocks the SoC, determining one or more pattern strings, wherein each of the strings identify a common functionality among a plurality of registers, performing a search on a register database for identifying a group of registers from the plurality of registers, wherein names of each of the group of registers include the pattern string, and generating a virtual register that relates to the group of register.

In one implementation, a spreadsheet template may be used to define the register/field patterns for discover in a named register space environment, which facilitates user definition of a register group. Other implementations disclosed herein, and as discussed below in further detail, define various functions that may be performed at the register group level. Examples of such functions include a get value function, a set value function, a filter function, a display function, a value check function, a value restore function, an error check function, etc.

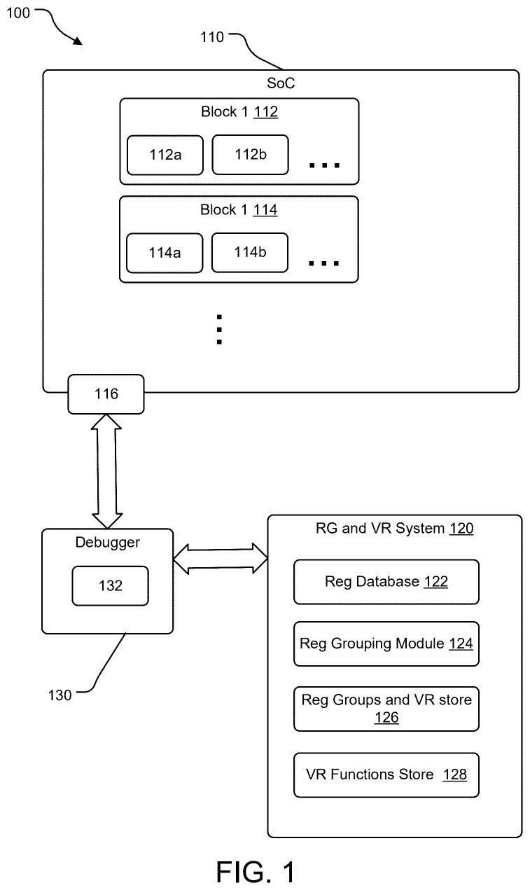

Now referring to the specific implementations, FIG. 1 illustrates an implementation of a system 100 providing register grouping and virtual register. The system 100 may include an SoC 110 that may be used for a computing device, such as, a computer, a mobile device, etc. The SoC 110 may include a number of functional blocks 112, 114, each of the functional blocks having a number of registers therein. For example, the functional block 112 may be a processor, the functional block 114 may be a memory block, etc.

The registers 112a, 112b on the functional block 112 may include a number of fields that specify the functional and operating parameters of the functional block 112. For example, for the functional block 112 being a processor, the register 112a may be a control register that changes or controls the general behavior of the processor or other digital device. For example, such a control register 112a may contain a number of flags, addresses, etc. Similarly, for a memory block 114 being a memory controller, the registers 114a may be a base register that specifies the start address of each bank, the register 114b may be an option register that specifies the bank length, etc.

Each of the registers 112a, 112b, 114a, 114b, etc., may also have a number of flipflops where particular values are programmed or stored. The values stored in these registers allow control of the functional block circuits. These values can be read from the registers or programmed into the registers using a debugger 130 or another application programming interface (API). For example, the debugger 130 may be connected to a socket 116 of the SoC 110 and may communicate to the registers 112a, 112b, 114a, 114b using the JTAG addresses of these registers. One or more scripts 132 that may be stored on a host system controlling the debugger 130 may read, modify, and write the values of the flipflops and fields of the registers 112a, 112b, 114a, 114b. For example, a system validation scrip 132 may check the values of various registers 112a, 112b, 114a, 114b and change if the read values based on the script commands.

In various prior implementations, each of the functional blocks 112, 114 required their own scripts for maintenance, update, validation of the functional blocks. This may result in extensive coding and maintenance for such individual functional block scripts. The system 100 disclosed herein overcomes such deficiency by providing register grouping and virtual register (VR) system 120 (referred to hereafter as the VR system 120). The VR system 120 is configured to find patterns among the registers and fields on the SoC 110 by performing search on the names and parameters of the registers to find patterns among them.

The illustrated implementation of the VR system 120 includes a register database 122 that includes documentation about the registers on various functional blocks on the SoC 110. Such a register database 122 may include names of the registers, various parameters of these registers such as their size in number of bits, their default values, their JTAG addresses, etc. For example, in one implementation, the register database 120 may store information about each register including its root level, its node, and its fields. Furthermore, any time a new functional block is added to the SoC 110, the register database 122 is updated to include the above information about all the registers of the newly added functional block. In this manner, the register database 122 is dynamic in that it maintains up to date information about all the registers.

The VR system 120 also includes a register grouping (RG) module 124 that performs search on all the register database to generate groupings of registers. For example, the VR system 120 may parse the names of the registers to find text strings in the names and compare them to the similar text strings found from other register names. As an example, the RG module 124 may parse the names to registers on all functional blocks of the SoC 110 to find registers with “clock” therein. Subsequently, the RG module 124 groups the registers that contains the string “clock” therein and creates a VR “SoC.clock” that relates to that group of registers. The RG module 124 may also store the RGs and the VRs in an RG and VR store 126. For example, the RG and VR store 126 may be a table where each entry relates a number of registers to their VR.

The VR system 120 also includes a VR functions store 128 that stores a number of functions that may be performed on the VRs. For example, the VR functions store 128 may store a get value function that gives the debugger 130 the ability to retrieve values of all register in the RG that are related to a VR. In one implementation, the get value function may also give additional capability to filter which registers are getting read, returning specific values. Similar VR functions, which are further described in detail below, may include a set value function, a filter function, a display function, a value check function, a value restore function, etc. The debugger 130 may provide an interface between a host system with one or more of the VR functions and the SoC. When the VR functions are executed by the host system, the host system may access the registers on the SoC 110, using the debugger 130, by their JTAG address to perform the functionality of such VR functions.

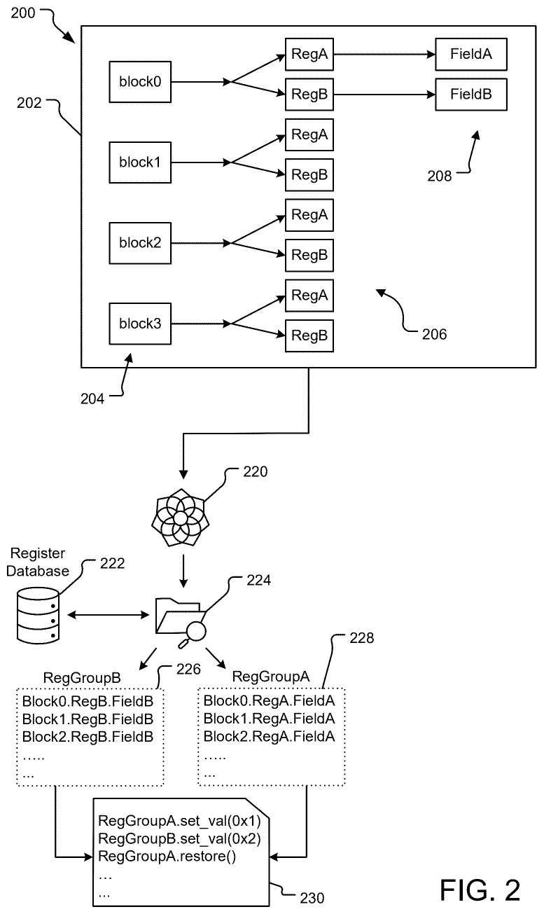

FIG. 2 illustrates an alternative implementation of a system 200 for providing register grouping and virtual register. Specifically, the system 200 may include an SoC 202 that includes a number of functional blocks 204, each of the functional blocks 204 including one or more registers 206, and the various registers 206 including one or more fields 208. A register database 222 may include information about the registers 206 and the fields 208. For example, such information may be functional information, names of the registers 206 including their root, node, and fields 208, the default values of the registers 206 and the fields 208, etc. Examples of the names of the registers 206 may be block0.regA.fieldA, etc.

The system 200 may also include register grouping (RG) logic 220 that performs various searches on the register database 222 to generate a register grouping 224 with virtual register (VR) names. For example, the RG logic 220 may filter the registers 206 to generate a register group 226 with VR name RegGroupB that incudes fields of the registers 206 that has “RegB” in its name string. Similarly, another register group 228 with VR name RegGroupA 228 may include fields of the registers 206 that has “RegA” in its name string.

The system 200 may also define various functions 230 that may be performed on the register groups 226, 228. For example, such functions may be set_val ( ), restore ( ), etc. As shown herein the set_val ( ) function may be executed on RegGroupA by executing command RegGroupA.set_val(0x1) to set the values of RegA.FieldA of the registers on various functional blocks 204. Similarly, the function restore( ) may be executed on RegGroupA by executing command RegGroupA.restore( ) to restore default values of the RegA.FieldA of the registers on various functional blocks 204.

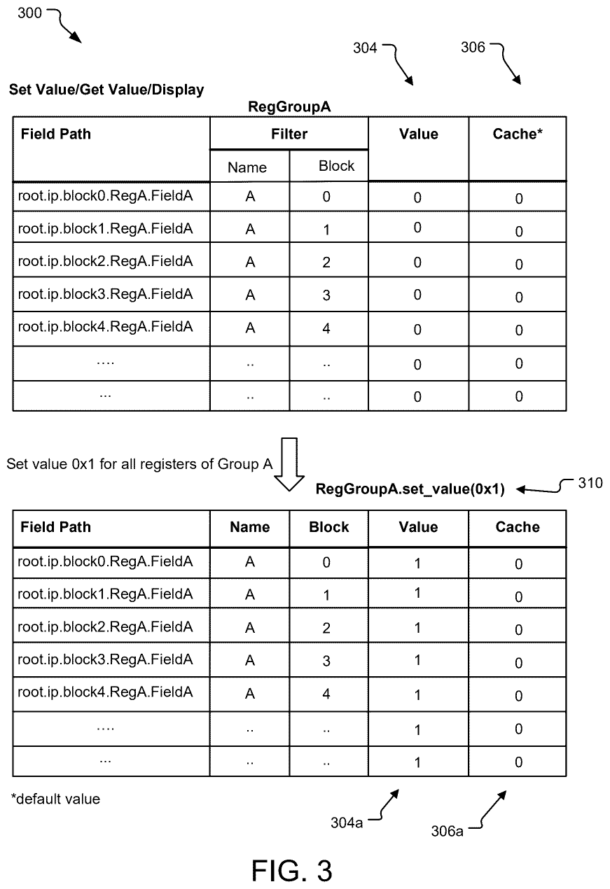

FIG. 3 illustrates a register function 300 that may be implemented using the register grouping and virtual register disclosed herein. Specifically, the register function 300 may be performed on registers in a register group RegGroup A with current field values 304 and cache (default) values 306. As illustrated, after performing the set_value(0x1) on RegGroupA by executing RegGroupA.set_value(0x1) 310, the values 304a of the fields A of the set of registers in this register group are changed to “1”, whereas the cache (default) values 306b remains the same at “0”. Specifically, set.value( ) function provides the host system the ability to set value of all registers defined in the group with the additional capability to filter which values get written.

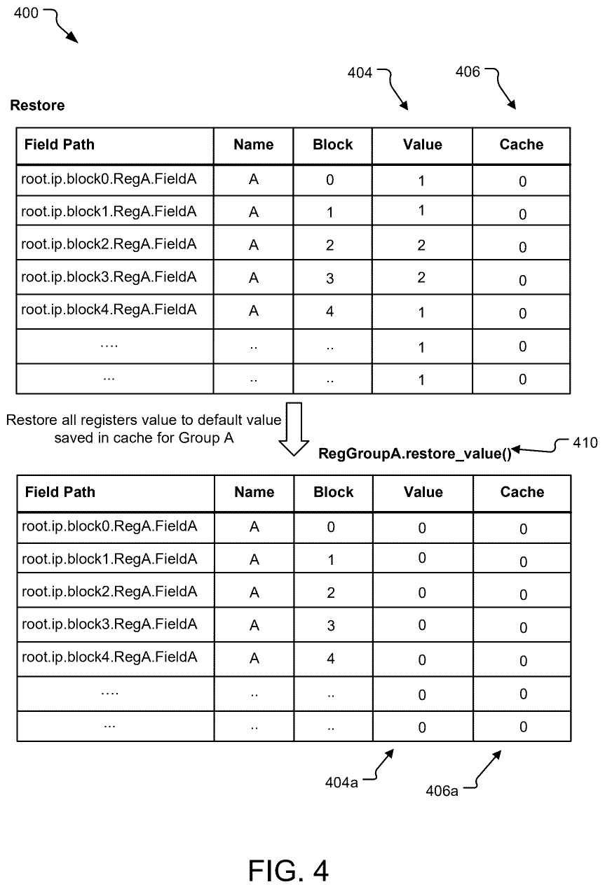

FIG. 4 illustrates a restore function 400 that may be implemented using the register grouping and virtual register disclosed herein. Specifically, the restore function 400 gives the host the ability to cache initial value 406 at time of group instantiation and restore later after the values 404 have been set to a different value. Thus, for example, after performing RegGropupA.restore_values ( ) 410, the current values 404a are updated to the cache values 406, 406a for all registers in the register group RegGroupA.

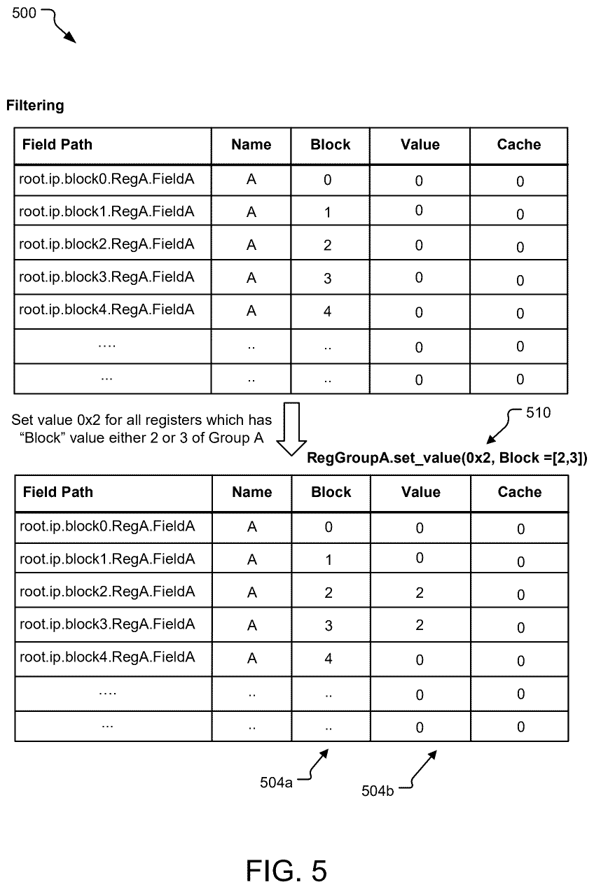

FIG. 5 illustrates a filter function 500 that may be implemented using the register grouping and virtual register disclosed herein. Specifically, the filter function 500 may allow advanced filtering based on keys extracted from the named register path. As illustrated here, the execution of set.val ( ) function with filter “Block=[2,3]” as RegGroupA.set_value (0x2, Block=[2,3]) 510 sets value 0x2 504b for all registers of register group A which has “Block” value 504a either 2 or 3.

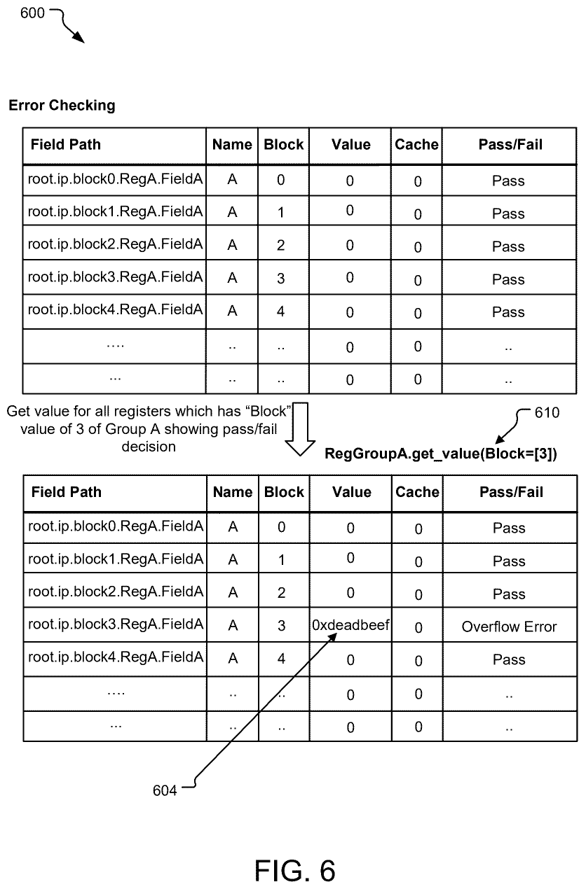

FIG. 6 illustrates an error checking function 600 that may be implemented using the register grouping and virtual register disclosed herein. The error checking function gives the ability to check read values against a specification and determine if the value passes or fails the check. Furthermore, custom feedback can also be given based on the read value. Thus, as shown, performing RegGroupA. get_value (Block=[3]) 610 gets values for all registers which has “Block” value of 3 604 of Group A showing pass/fail decision indicating an overflow error.

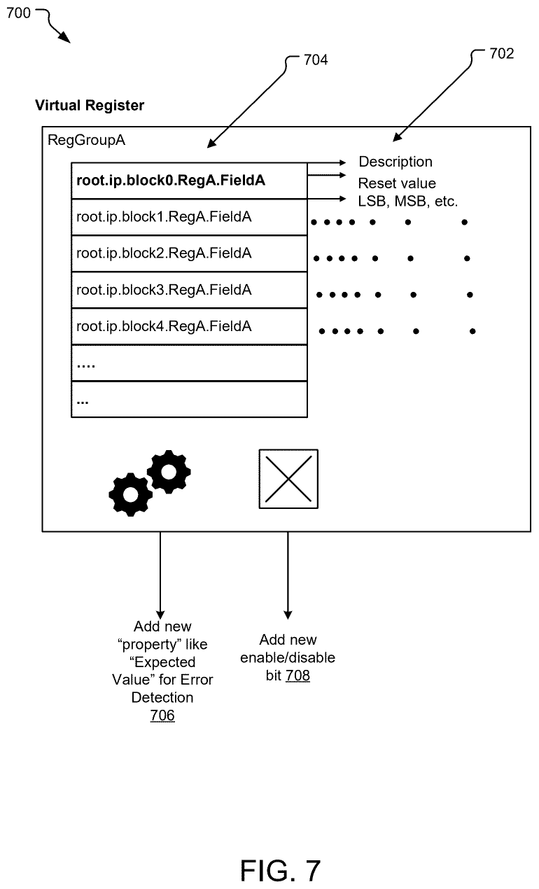

FIG. 7 illustrates an implementation 700 of using the virtual register to add new properties thereto. For example, as illustrated a new attribute 702 such as description, reset value, MSB, LSB, may be added to all fields 704 of registers that are part of RegGroupA. Additionally, by using a virtual register for the group of registers, a new property 706, such as expected value can be attached to the group of registers, which allows for error detection if the actual value is not equal to the expected value. Additionally, a new bit, such as enable/disable bit 708 may also be added to the registers that are part of a particular register group such as RegGroupA.

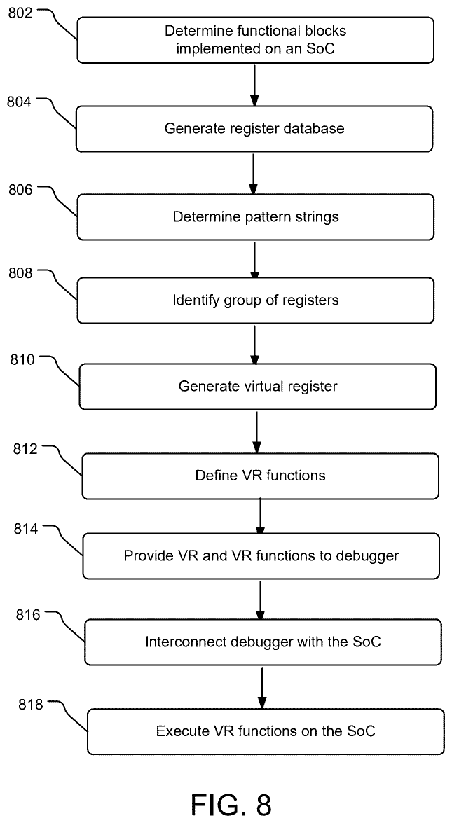

FIG. 8 illustrates a flowchart of operations 800 of providing register grouping and virtual register disclosed herein. An operation 802 determines various functional blocks implemented on an SoC. For example, such functional blocks may include various processors, IO modules, memory modules, etc.

An operation 804 generates a register database. For example, generating the register database may include receiving information about the registers on various functional blocks on the SoC. Such information about the registers may include register names, their length in bits, various fields, the default values, etc.

An operation 806 determines one or more pattern strings that can be used to identify groups of registers that belong in a register group. For example, the pattern strings identify a common functionality among the registers. For example, a search may identify all the registers that have a term “powerDwn,” which indicates the value of the register when power goes down.

An operation 808 performs a search on the register database to determine group of registers where names of each of the group of registers include the pattern string. For example, the operation 808 may find all registers with the term “clock” in its name to identify a group of register fields that are likely the clock values.

An operation 810 may generate a virtual register that relates to the group of registers identified at 808. Subsequently, an operation 812 defines various virtual register functions. For example, the operation 812 defines various virtual register functions that, when executed on the virtual register, performs the virtual register function on each register of the group of registers.

At operation 814, the information about the virtual registers' definitions and the virtual register functions may be provided to a host system controlling the debugger. Here the host system may be able to connect to the SoC via a debugger socket. At operation 816, the debugger is connected to the SoC and subsequently, an operation 818 executes the virtual register functions stored on the host system on the SoC via the debugger. For example, the debugger may have a number of JTAG addresses identifying the various registers of a register group abstracted at the VR level and when a VR function is executed, it executes that function to communicate with the registers identified by the JTAG addresses.

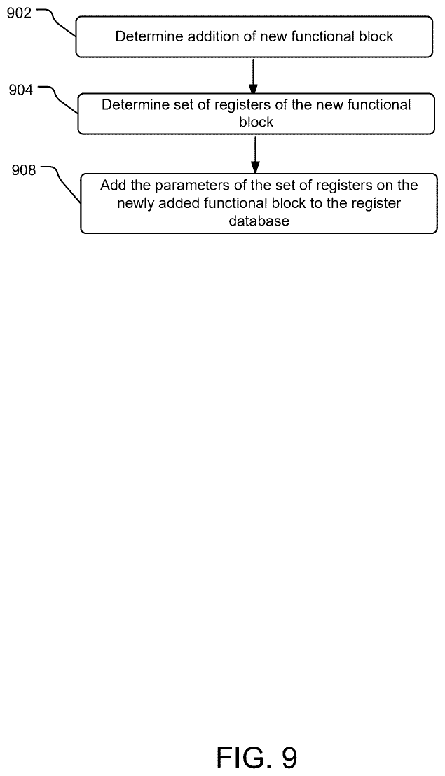

FIG. 9 illustrates operations 900 for dynamically updating the register database. An operation 902 determines that a new functional block is added to the SoC. In response, an operation 904 determines a set of registers on the newly added functional block. Subsequently, an operation 906 adds information about the registers including the parameters of the set of registers on the newly added functional block to the register database.

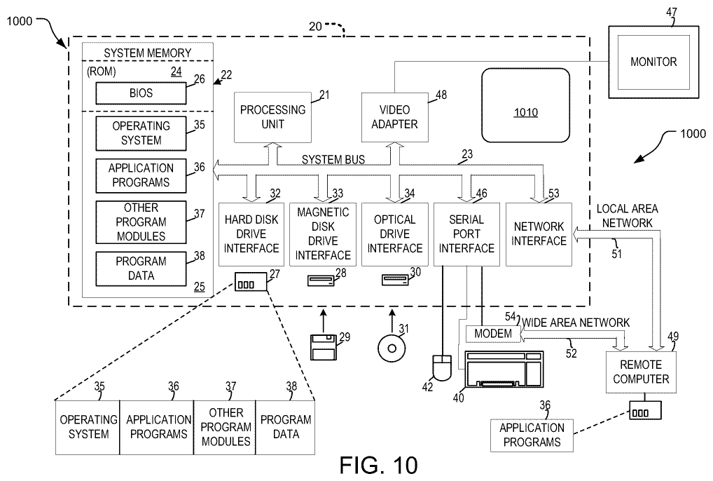

FIG. 10 illustrates an example system 1000 that may be useful in implementing the system for providing forward and reverse mapping between physical address and DRAM address disclosed herein. The example hardware and operating environment of FIG. 10 for implementing the described technology includes a computing device, such as a general-purpose computing device in the form of a computer 20, a mobile telephone, a personal data assistant (PDA), a tablet, smart watch, gaming remote, or other type of computing device. In the implementation of FIG. 10, for example, the computer 20 includes a processing unit 21, a system memory 22, and a system bus 23 that operatively couples various system components, including the system memory 22 to the processing unit 21. There may be only one or there may be more than one processing units 21, such that the processor of a computer 20 comprises a single central-processing unit (CPU), or a plurality of processing units, commonly referred to as a parallel processing environment. The computer 20 may be a conventional computer, a distributed computer, or any other type of computer; the implementations are not so limited.

The system bus 23 may be any of several types of bus structures, including a memory bus or memory controller, a peripheral bus, a switched fabric, point-to-point connections, and a local bus using any of a variety of bus architectures. The system memory 22 may also be referred to as simply the memory and includes read-only memory (ROM) 24 and random-access memory (RAM) 25. A basic input/output system (BIOS) 26, contains the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The computer 20 may be used to implement a high latency query optimization system disclosed herein. In one implementation, a frequency unwrapping module, including instructions to unwrap frequencies based at least in part on the sampled reflected modulations signals, may be stored in memory of the computer 20, such as the read-only memory (ROM) 24 and random-access memory (RAM) 25.

Furthermore, instructions stored on the memory of the computer 20 may be used to generate a transformation matrix using one or more operations disclosed in FIG. 10. Similarly, instructions stored on the memory of the computer 20 may also be used to implement one or more operations of FIG. 1. The memory of the computer 20 may also one or more instructions to implement the high latency query optimization system disclosed herein.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide non-volatile storage of computer-readable instructions, data structures, program modules and other data for the computer 20. It should be appreciated by those skilled in the art that any type of tangible computer-readable media may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device, or other common network node, and typically includes many or all of the elements described above relative to the computer 20. The logical connections depicted in FIG. 7 include a local-area network (LAN) 51 and a wide-area network (WAN) 52. Such networking environments are commonplace in office networks, enterprise-wide computer networks, intranets, and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of communications devices for establishing a communications link between the computers may be used.

In an example implementation, software, or firmware instructions for the system 1010 for providing register grouping and virtual register may be stored in system memory 22 and/or storage devices 29 or 31 and processed by the processing unit 21. high latency query optimization system operations and data may be stored in system memory 22 and/or storage devices 29 or 31 as persistent data-stores.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments of high latency query optimization system may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain function. The instructions may be implemented using any suitable high-level, low-level, object-oriented, visual, compiled and/or interpreted programming language.

The high latency query optimization system disclosed herein may include a variety of tangible computer-readable storage media and intangible computer-readable communication signals. Tangible computer-readable storage can be embodied by any available media that can be accessed by the high latency query optimization system disclosed herein and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the high latency query optimization system disclosed herein. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals moving through wired media such as a wired network or direct-wired connection, and signals moving through wireless media such as acoustic, RF, infrared and other wireless media.

A method disclosed herein includes generating a register database, wherein the register database is configured to store one or more parameters of a plurality of registers, the plurality of registers representing the registers for a plurality of functional blocks on a system on chip (SoC), determining one or more pattern strings, wherein each of the pattern strings identify a common functionality among the plurality of registers, performing a search on a register database for identifying a group of registers from the plurality of registers, wherein names of each of the group of registers include the pattern string, and generating a virtual register definition that relates to the group of registers.

One or more physically manufactured computer-readable storage media disclosed herein, encodes computer-executable instructions for executing on a computer system a computer process, the computer process including generating a register database, wherein the register database is configured to store one or more parameters of a plurality of registers, the plurality of registers representing the registers for a plurality of functional blocks on a system on chip (SoC), determining one or more pattern strings, wherein each of the pattern strings identify a common functionality among the plurality of registers, performing a search on a register database for identifying a group of registers from the plurality of registers, wherein names of each of the group of registers include the pattern string, and generating a virtual register definition that relates to the group of registers.

A system disclosed herein includes a memory, one or more processing units, and a register grouping system stored in the memory and executable by the one or more processor units, the register grouping system encoding computer-executable instructions on the memory for executing on the one or more processor units a computer process, the computer process including generating a register database, wherein the register database is configured to store one or more parameters of a plurality of registers, the plurality of registers representing the registers for a plurality of functional blocks on a system on chip (SoC), determining one or more pattern strings, wherein each of the pattern strings identify a common functionality among the plurality of registers, performing a search on a register database for identifying a group of registers from the plurality of registers, wherein names of each of the group of registers include the pattern string, and generating a virtual register definition that relates to the group of registers.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A method, comprising:
generating a register database, wherein the register database is configured to store one or more parameters of a plurality of registers, the plurality of registers representing the registers for a plurality of functional blocks on a system on chip (SoC);
determining one or more pattern strings, wherein each of the pattern strings identify a common functionality among the plurality of registers;
performing a search on a register database for identifying a group of registers from the plurality of registers, wherein names of each of the group of registers include the pattern string; and
generating a virtual register definition that relates to the group of registers.

2. The method of claim 1, further comprising defining one or more virtual register functions, wherein the virtual register function, when executed on the virtual register, performs the virtual register function on each register of the group of registers.

3. The method of claim 2, further comprising:
providing virtual register definitions and the one or more virtual register functions to a debugger module;
communicatively connecting the debugger module to the SoC; and
executing one or more of the virtual register functions on the SoC.

4. The method of claim 2, wherein the debugger module is configured to perform a mapping between the virtual register and a plurality of JTAG addresses on one or more of the plurality of functional blocks.

5. The method of claim 2, wherein the register database is configured to store a cache value representing a default value of the one or more registers and a current value representing a current value of the one or more registers.

6. The method of claim 2, wherein the one or more virtual register functions includes at least one of a set value function and a get value function.

7. The method of claim 2, wherein the one or more virtual register functions includes at least one of a restore function, a filter function, and an error check function.

8. The method of claim 1, further comprising:
determining an addition of a new functional block to the SoC;
determining a set of registers on the newly added functional block; and
adding the parameters of the set of registers on the newly added functional block to the register database.

9. One or more physically manufactured computer-readable storage media, encoding computer-executable instructions for executing on a computer system a computer process, the computer process comprising:
determining a plurality of functional blocks configured on a system on chip (SoC);
generating a register database, wherein the register database is configured to store one or more parameters of a plurality of registers, the plurality of registers representing the registers for a plurality of functional blocks on an SoC;
determining one or more pattern strings, wherein each of the pattern strings identify a common functionality among the plurality of registers;
performing a search on a register database for identifying a group of registers from the plurality of registers, wherein names of each of the group of registers include the pattern string; and
generating a virtual register definition that relates to the group of registers.

10. The one or more physically manufactured computer-readable storage media of manufacture of claim 9, wherein the computer process further comprising defining one or more virtual register functions, wherein the virtual register function, when executed on the virtual register, performs the virtual register function on each register of the group of registers.

11. The one or more physically manufactured computer-readable storage media of manufacture of claim 10, wherein the computer process further comprising:
providing virtual register definitions and the one or more virtual register functions to a debugger module;
communicatively connecting the debugger module to the SoC; and
executing one or more of the virtual register functions on the SoC.

12. The one or more physically manufactured computer-readable storage media of manufacture of claim 10, wherein the debugger module is configured to perform a mapping between the virtual register and a plurality of JTAG addresses on one or more of the plurality of functional blocks.

13. The one or more physically manufactured computer-readable storage media of manufacture of claim 10, wherein the register database is configured to store a cache value representing a default value of the one or more registers and a current value representing a current value of the one or more registers.

14. The one or more physically manufactured computer-readable storage media of manufacture of claim 10, wherein the one or more virtual register functions includes at least one of a set value function, a get value function, a restore function, a filter function, and an error check function.

15. The one or more physically manufactured computer-readable storage media of manufacture of claim 9, wherein the computer process further comprising:
determining an addition of a new functional block to the SoC;
determining a set of registers on the newly added functional block; and
adding the parameters of the set of registers on the newly added functional block to the register database.

16. A system comprising:
memory;
one or more processing units; and
a register grouping system stored in the memory and executable by the one or more processor units, the register grouping system encoding computer-executable instructions on the memory for executing on the one or more processor units a computer process, the computer process comprising:
generating a register database, wherein the register database is configured to store one or more parameters of a plurality of registers, the plurality of registers representing the registers for a plurality of functional blocks on a system on chip (SoC);
determining one or more pattern strings, wherein each of the pattern strings identify a common functionality among the plurality of registers;
performing a search on a register database for identifying a group of registers from the plurality of registers, wherein names of each of the group of registers include the pattern string; and
generating a virtual register definition that relates to the group of registers.

17. The system of claim 16, wherein the computer process further comprising: defining one or more virtual register functions, wherein the virtual register function, when executed on the virtual register, performs the virtual register function on each register of the group of registers.

18. The system of claim 17, wherein the computer process further comprising:
providing virtual register definitions and the one or more virtual register functions to a debugger module;
communicatively connecting the debugger module to the SoC; and
executing one or more of the virtual register functions on the SoC.

19. The system of claim 17, wherein the debugger module is configured to perform a mapping between the virtual register and a plurality of JTAG addresses on one or more of the plurality of functional blocks.

20. The system of claim 17, wherein the register database is configured to store a cache value representing a default value of the one or more registers and a current value representing a current value of the one or more registers.
